(19) United States
(12) Patent Application Publication
(10) Pub. No.: US 2022/0348080 A1
(43) Pub. Date: Nov. 3, 2022

(54) CONTROL OF A DISPLAY OF AN AUGMENTED REALITY HEAD-UP DISPLAY APPARATUS FOR A MOTOR VEHICLE

(71) Applicant: Volkswagen Aktiengesellschaft, Wolfsburg (DE)

(72) Inventors: Vitalij Sadovitch, Braunschweig (DE); Onur de Godoy Aras, Wolfsburg (DE); Adrian Haar, Hannover (DE)

(21) Appl. No.: 17/618,386

(22) PCT Filed: May 18, 2020
(86) PCT No.: PCT/EP2020/063871

§ 371 Date: Dec. 10, 2021

(30) Foreign Application Priority Data
Jun. 13, 2019 (DE) 10 2019 208 649.7

(51) Int. Cl. B60K 35/00; G06F 3/01

(52) U.S. Cl. CPC B60K 35/00; G06F 3/013; B60K 2370/149; B60K 2370/1529; B60K 2370/177; B60K 2370/1868; B60K 2370/188; B60K 2370/52

(57) ABSTRACT

Controlling a display of an augmented reality head-up display for a motor vehicle. The content to be displayed by the augmented reality head-up display may be initially analyzed. In so doing, there can optionally be a prioritization of the content to be displayed. Subsequently, a position of an eyebox of the augmented reality head-up display is adapted on the basis of the content to be displayed.

### CROSS REFERENCE TO RELATED APPLICATION

The present application claims priority to International Patent App. No. PCT/EP2020/063871 to Sadovitch, et al., titled “Control of A Display of An Augmented Reality Head-Up Display Apparatus for A Motor Vehicle”, filed May 18, 2020, which claims priority to German Patent App. No 10 2019 208 649.7, filed Jun. 13, 2019, the contents of each being incorporated by reference in their entirety herein.

### FIELD OF TECHNOLOGY

The present disclosure relates to a method, a computer program with instructions and an apparatus for controlling a display of an augmented reality head-up display for a motor vehicle. The present disclosure further relates to a motor vehicle wherein a method according to the present disclosure or an apparatus according to the present disclosure is utilized.

### BACKGROUND

Parallel to the continuous improvement of virtual and augmented reality technologies in general applications, these modalities are also finding their way into automobiles. Augmented Reality (AR) (German: “erweiterte Realitat”) denotes the enrichment of the real world with virtual elements that are correctly registered in three-dimensional space and allow for real-time interactions with them. Since the term “augmented reality” has prevailed in the German-speaking expert community over the term “erweiterte Realitat,” the same will be used in the following. The term “mixed reality” is used synonymously.

The head-up display (HUD) offers a possible technical implementation for enriching the driver's workstation accordingly with perspective-correct virtual extensions. For this purpose, the light rays from a display built into the dashboard are folded over several mirrors and lenses and reflected into the driver's eye via a projection surface whereby the driver perceives a virtual image outside the vehicle. In the automotive sector, the windshield is often used as a projection surface, the curved shape of which must be taken into account for the representation. As an alternative, an additional pane made of glass or plastic is sometimes used, which is arranged on the dashboard between the driver and the windshield. Visually superimposing the display and the driving scene means that fewer head and eye movements are required to read the information. In addition, the adaptation effort for the eyes is reduced, since, depending on the virtual distance of the display, there is less or no need to accommodate.

Augmented Reality offers a wide range of possible applications in support of the driver namely through contact-analog marking of lanes and objects. Relatively obvious examples mostly relate to the area of navigation. While classic navigation displays in conventional head-up displays usually show schematic displays, e.g., a right-angled arrow pointing to the right as a sign that a right turn should be made at the next opportunity, AR displays offer substantially more effective options. Since the displays can be represented as “part of the environment,” the driver can, for example, very effective navigation instructions or hazard warnings can be presented to the driver directly at the real reference point.

The display area of a head-up display, wherein virtual content can be displayed in the windshield, is described by the field of view (FOV). The area from which the display is visible is called an eyebox. The field of view indicates the extent of the virtual image in the horizontal and vertical directions in degrees and is essentially limited by the available installation space inside the vehicle. With conventional technology, a field of view of about 10°×4° can be achieved. The limited size of the field of view means that, in many situations, essential display content in augmented reality applications cannot be displayed, or it can only be displayed to a limited extent.

A first approach to solving this problem is to increase the size of the field of view, for example, by utilizing alternative display technologies. For example, by using holographic components, a larger field of view can be achieved with the same or even reduced structural volume.

In this context, US 2012/0224062 A1 describes a head-up display for a motor vehicle. The head-up display utilizes a laser-based imaging system for a virtual image. The imaging system comprises at least one laser light source, which is coupled to imaging optics, to provide a beam of light that carries two-dimensional virtual images. A fiber optic cable for expanding an exit pupil is optically coupled to the laser-based virtual imaging system in order to receive the light beam and to enlarge an eyebox of the head-up display for viewing the virtual images.

Another approach for a solution is adapting the position of the eyebox to the driver's head position so that the driver's eyes are in the center of the eyebox and a field of view that is as large as possible is effectively available.

Against this background, DE 10 2015 010 373 A1 describes a method for adapting a position of a virtual image of a head-up display of a motor vehicle to a field of view of a user. The head-up display has a housing with an adjustment facility which, in response to an operating action by the user, is brought into a desired position wherein the virtual image is in the user's field of view.

In combination with head tracking, a customized and even automatic adjustment of the eyebox can be implemented, depending on the driver's head position. Dynamic movements of the driver therein can also be compensated in that the eyebox undergoes continuous adapting.

### SUMMARY

Aspects of the present disclosure are to provide alternative solutions for controlling a display of an augmented reality head-up display for a motor vehicle that will enable reducing the disadvantages resulting from the limited size of the field of view.

Some aspects of the present disclosure are described in the subject matter of the independent claims, found below. Other aspects of the present disclosure are described in the subject matter of the dependent claims.

In some examples, a method is disclosed for controlling a display of an augmented reality head-up display for a motor vehicle, comprising analyzing content to be displayed by the augmented reality head-up display; and adapting a position of an eyebox of the augmented reality head-up display as a function of the content to be displayed.

In some examples, a computer program is disclosed having instructions which, when executed by a computer, cause the computer to carry out the following steps for controlling a display of an augmented reality head-up display for a motor vehicle: analyzing content to be displayed by the augmented reality head-up display; and adapting a position of an eyebox of the augmented reality head-up display as a function of the content to be displayed.

The term computer is to be understood broadly. In particular, it may also include control devices and other processor-based data processing apparatuses.

The computer program can, for example, be provided for electronic retrieval, or it can be stored in a computer-readable storage medium.

In some examples, an apparatus is disclosed for controlling a display of an augmented reality head-up display for a motor vehicle, wherein the apparatus includes an analysis module for analyzing content to be displayed by the augmented reality head-up display; and a control module for adapting a position of an eyebox of the augmented reality head-up display as a function of the content to be displayed.

Due to the optical design of head-up displays, the virtual image may be perceived only when the viewer's eyes are located in a defined eyebox. The solution according to the present disclosure alleviates the disadvantages resulting from the limited size of the field of view by providing that the position of the eyebox is adjusted as a function of the virtual content. No additional technology may therefore be required to enlarge the virtual image; instead, the limited image area is utilized in an optimized manner. Therefore, the solution according to the present disclosure can be implemented cheaply, and it does not require any adaptation of the installation space required for the head-up display.

According to one aspect of the present disclosure, as a function of the content to be displayed, the eyebox of the augmented reality head-up display may be shifted vertically. The virtual image that is rendered for representation in the head-up display should always be one buffer larger than the image that the head-up display can depict. Assuming, for example, a head-up display with a vertical field of view of 4° and a buffer of 0.5° each above and below the image boundaries, an image should be rendered that is for a field of view of 5°. By shifting the vertical position, the field of view is now dynamically expanded to include the area of the buffer. Of course, as an alternative or in addition, the eyebox can also be shifted horizontally if a buffer is provided to the right and left of the image boundaries.

According to one aspect of the present disclosure, the position of the eyebox may be adapted by adjusting an optical component of the augmented reality head-up display. Many head-up displays already provide the option of being able to shift the eyebox in the vertical direction by adjusting the mirror in the optics of the head-up display. This is used to adapt the position of the eyebox relative to the head position of the observer. In fact, this setting option can also be utilized to adapt the position of the eyebox as a function of the content that is to be displayed. No additional adjustment options are therefore required.

According to one aspect of the present disclosure, when analyzing the content to be displayed by the augmented reality head-up display, an image that is rendered for the display is analyzed. For example, color values of the image can be analyzed therein. A dynamic analysis of the rendered image can be carried out for the situation-dependent adjustment of the eyebox. For representation in the head-up display, an image may be rendered with a black background, because black appears as transparent in the head-up display. The buffer areas can therefore be automatically checked for the occurrence of pixels whose RGB color value does not correspond to (0,0,0). If this check is positive, the eyebox is shifted. The eyebox is adjusted upward, if content is to be displayed in the upper buffer area, and downward, if content is to be displayed in the lower buffer area. Such a color analysis can, of course, also be implemented for other color spaces.

According to one aspect of the present disclosure, while analyzing the content to be displayed by the augmented reality head-up display, input data for a rendering of an image for the display are analyzed. Since the adjustment of the eyebox is usually done mechanically, and it is therefore associated with high latency, it makes sense to carry out the check of the content that is to be displayed predictively. Instead of analyzing the already rendered image, in said case, the evaluation takes place before the rendering, on the basis of the input data.

According to one aspect of the present disclosure, the content that to be displayed is prioritized. Thus, it is preferably ensured that the adjustment of the eyebox and of the display area of the head-up display associated with the same does not mean that other content that is to be displayed cannot in fact be displayed. Therefore, it makes sense to check not only the buffer areas with regard to the content that is to be displayed, but also the display area. The eyebox should only be adjusted insofar that other content of the rendered image does not fall out of the representational area. If the content that is to be displayed does not completely fit into the representational area, the content that is to be displayed is prioritized. In this way, it can be determined which content that is to be represented will be truncated.

According to one aspect of the present disclosure, the prioritization is dependent on a driving situation, or it can be influenced by a user of the augmented reality head-up display.

For example, it can be provided that, when driving on the freeway, navigation instructions have a lower priority than information on people, while, when driving in a city, navigation instructions are given a higher priority than information on people. In this context, it makes sense to differentiate between people on the side of the road and people in the middle of the road. In one example, important warnings alerting to dangerous situations should always be given the highest priority. The user of the head-up display can preferably determine what virtual content is to be prioritized in order to be able to adapt the behavior of the head-up display to their own preferences.

A method according to the present disclosure or an apparatus according to the present disclosure is particularly advantageously utilized in a vehicle, in particular a motor vehicle.

### BRIEF DESCRIPTION OF THE DRAWINGS

Further features of the present disclosure will become apparent from the following description and the appended claims in conjunction with the figures.

FIG. 1 shows an approach to an intersection, seen from the driver's perspective, at a configured distance from the intersection according to some aspects of the present disclosure;

FIG. 2 shows the approach to the intersection, seen from the driver's perspective, at a short distance from the intersection according to some aspects of the present disclosure;

FIG. 3 shows, schematically, a method for controlling a display of an augmented reality head-up display for a motor vehicle according to some aspects of the present disclosure;

FIG. 4 shows a first embodiment of an apparatus for controlling a display of an augmented reality head-up display for a motor vehicle according to some aspects of the present disclosure;

FIG. 5 shows a second embodiment of an apparatus for controlling a display of an augmented reality head-up display according to some aspects of the present disclosure;

FIG. 6 shows, schematically, a motor vehicle inside which a solution according to the present disclosure has been implemented according to some aspects of the present disclosure;

FIG. 7 schematically shows a general structure of an augmented reality head-up display for a motor vehicle according to some aspects of the present disclosure;

FIG. 8 shows a representational area of a head-up display and adjoining tolerance areas for different positions of the eyebox according to some aspects of the present disclosure;

FIG. 9 shows a turning situation, which is to be illustrated by means of an augmented reality display according to some aspects of the present disclosure;

FIG. 10 shows an augmented reality representation of a navigation marking without any shifting of the eyebox according to some aspects of the present disclosure; and

FIG. 11 shows an augmented reality representation of the navigation marking with the eyebox shifted consistent with the situation according to some aspects of the present disclosure.

### DETAILED DESCRIPTION

For a better understanding of the principles of the present disclosure, embodiments of the present disclosure will be explained in more detail below with reference to the figures. It is understood that the present disclosure is not limited to these embodiments and that the features described can also be combined or modified without departing from the scope of the present disclosure as defined in the appended claims.

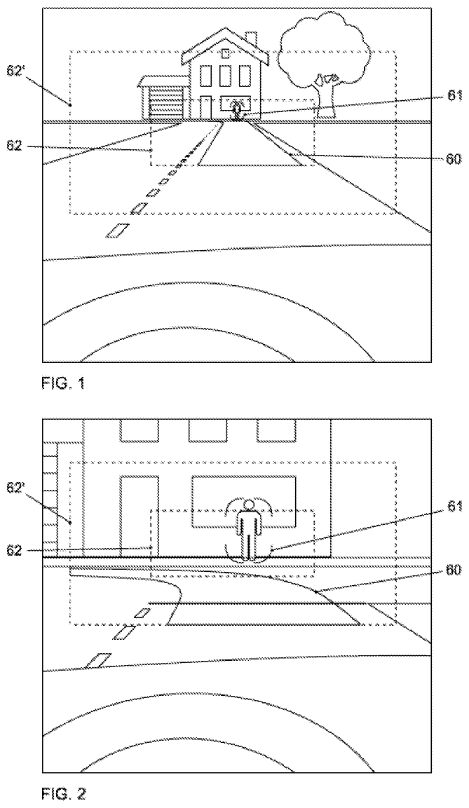

FIG. 1 shows an approach to an intersection, seen from the driver's perspective, at a great distance from the intersection. The augmented reality head-up display represents, on the one hand, a contact-analog navigation marking 60, here in the form of a visualized trajectory of a vehicle approaching an intersection, and, on the other hand, a contact-analog object marking 61, here in the form of a frame around a person. Also displayed are two different fields of view 62, 62′, a large field of view 62′ corresponding to an angular range of 20°×10° and a small field of view 62 corresponding to an angular range of 10°×4°. At this distance, the virtual content can be represented without any problems for both sizes of the fields of view 62, 62′.

FIG. 2 shows the approach to the intersection, seen from the driver's perspective, at a short distance from the intersection. At this distance, the representations of both the contact-analog navigation marking 60 and the contact-analog object marking 61 are severely truncated by the small field of view 62. The navigation marking 60 can hardly be recognized as such. This effect reduces the added value and the user experience of an augmented reality head-up display.

FIG. 3 schematically shows a method for controlling a display of an augmented reality head-up display for a motor vehicle. In a first step 10, the content to be displayed by the augmented reality head-up display is analyzed. For example, an image rendered for the display can be analyzed, in particular its color values. Alternatively, input data for rendering an image can also be analyzed for the display. Optionally, the content to be displayed can also be prioritized 11. This prioritization can be a function of a driving situation, or it can be influenced by a user. A position of an eyebox of the augmented reality head-up display is then adapted as a function of the content that is to be displayed 12. The eyebox is preferably shifted at least vertically. The position of the eyebox can, for example, be adapted by adjusting an optical component of the augmented reality head-up display 12.

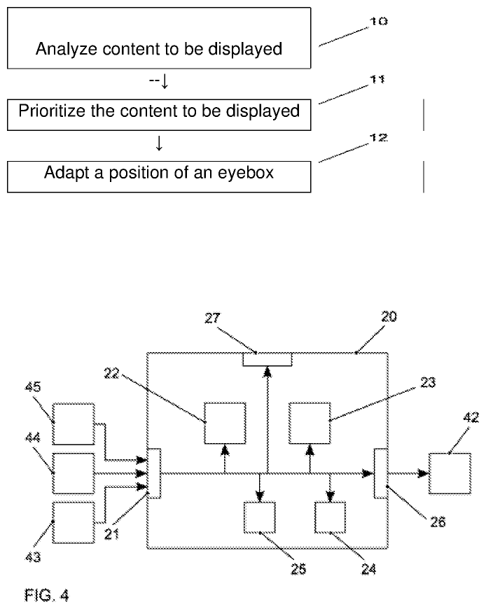

FIG. 4 shows a simplified schematic representation of a first embodiment of an apparatus 20 for controlling a display of an augmented reality head-up display for a motor vehicle. The apparatus 20 has an input 21 via which, for example, image data from a camera 43, data from a sensor system 44 or data from a navigation system 45 can be received. The sensor system 44 can, for example, have a laser scanner or a stereo camera for detecting objects in the surroundings of the motor vehicle. The apparatus 20 also has an analysis unit 22 which can analyze the content to be displayed by the augmented reality head-up display, in particular with regard to its representational capacity in a display area of the augmented reality head-up display. For example, the analysis unit 22 can be configured to analyze an image rendered for the display, in particular its color values. Alternatively, input data for rendering an image can also be analyzed for the display. The analysis unit 22 can also prioritize the content to be displayed. This prioritization can be a function of a driving situation, or it can be subject to being influenced by a user. Finally, a control module 23 causes an adaptation of a position of an eyebox of the augmented reality head-up display as a function of the content that is to be displayed. Therein, at least one vertical shift of the eyebox preferably occurs. The position of the eyebox can be adapted, for example, by adjusting an optical component of the augmented reality head-up display. Control signals from the control module 23 can be output via an output 26 of the apparatus 20, e.g., to a control device 42 of the augmented reality head-up display.

The analysis unit 22 and the control module 23 can be controlled by a control unit 24. If necessary, settings of the analysis unit 22, the control module 23 or the control unit 24 can be changed via a user interface 27. The data collected by the apparatus 20 can, if necessary, be stored in a memory 25 of the apparatus 20, for example, for later analysis or for utilization by the components of the apparatus 20. The analysis unit 22, the control module 23 and the control unit 24 can be implemented as dedicated hardware, for example, as integrated circuits. Of course, they can also be partially or fully combined or implemented as software that is executed on a suitable processor, for example, a GPU. The input 21 and the output 26 can be implemented as separate interfaces or as one combined bidirectional interface. In the example that is described here, the apparatus 20 is an independent component. However, it can also be integrated in the control unit 42 of the augmented reality head-up display apparatus.

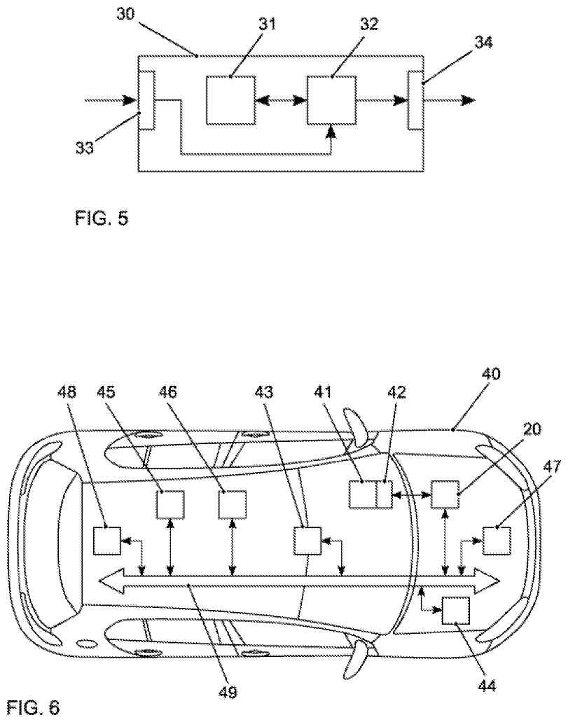

FIG. 5 shows a simplified schematic representation of a second embodiment of an apparatus 30 for controlling a display of an augmented reality head-up display for a motor vehicle. The apparatus 30 has a processor 32 and a memory 31. For example, the apparatus 30 is a computer or a control unit. Residing in the memory 31 are instructions that have been stored there which, when executed by the processor 32, cause the apparatus 30 to execute the steps according to any one of the described methods. The instructions that are stored in the memory 31 therefore embody a program which can be executed by the processor 32 that implements the method according to the present disclosure. The apparatus 30 has an input 33 for receiving information, for example, navigation data or data relating to the surroundings of the motor vehicle. Data generated by the processor 32 are provided via an output 34. In addition, they can be stored in memory 31. The input 33 and the output 34 can be combined to form a bidirectional interface.

The processor 32 may comprise one or more processing units, for example, microprocessors, digital signal processors, or combinations thereof.

The memories 25, 31 of the described embodiments can have volatile and non-volatile data storage areas, and they can comprise a wide variety of storage apparatuses and storage media, for example, hard drives, optical storage media, or semiconductor memories.

FIG. 6 schematically shows a motor vehicle 40 where a solution according to the present disclosure has been implemented. The motor vehicle 40 has an augmented reality head-up display 41 with an associated control device 42. Furthermore, the motor vehicle 40 has an apparatus 20 for controlling a display of the augmented reality head-up display 41. The apparatus 20 can, of course, also be integrated in the augmented reality head-up display 41 or in the control device 42 of the augmented reality head-up display 41. Further components of the motor vehicle 40 are a camera 43 and a sensor system 44 for detecting objects, a navigation system 45, a data transmission unit 46, and a number of assistance systems 47, wherein one of these assistance system is shown as an example. A connection to service providers can be established by means of the data transmission unit 46, for example, for retrieving map data. A memory 48 is provided for storing data. The data exchange between the various components of the motor vehicle 40 takes place via a network 49.

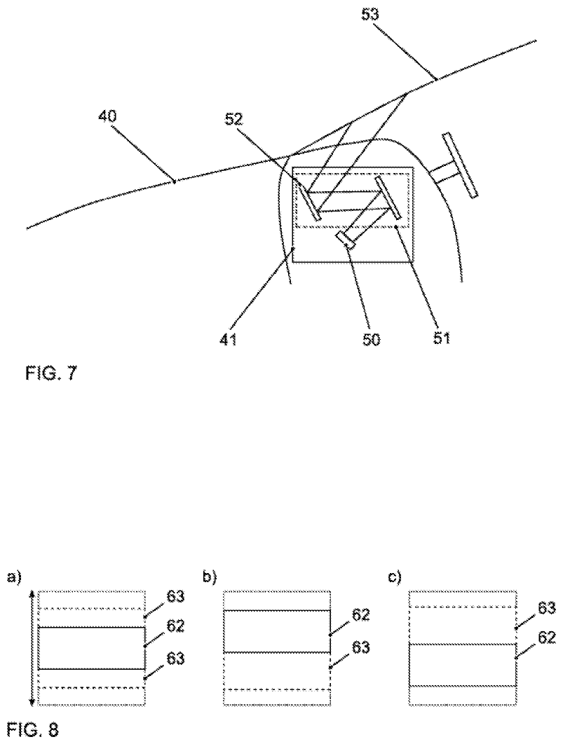

FIG. 7 schematically shows an augmented reality head-up display 41 for a motor vehicle 40 that is used for displaying content on a projection area 53 of the motor vehicle 40, for example, on the windshield or on an additional pane made of glass or plastic, which is arranged on the dashboard between the driver and the windshield. The displayed content is generated by means of an imaging unit 50 and projected onto the projection surface 53 with the aid of an optical module 51. The projection typically occurs in an area of the windshield and above the steering wheel. The position of an eyebox of the augmented reality head-up display 41 can be adapted by means of an optical component 52 of the optical module 51. The imaging unit 50 can be an LCD-TFT display, for example. The augmented reality head-up display 41 is usually installed in a dashboard of the motor vehicle 40.

A preferred embodiment of the present disclosure will be described below with reference to FIGS. 8 to 11.

FIG. 8 shows a field of view 62 of a head-up display and tolerance ranges 63 for different positions of the eyebox adjacent thereto. FIG. 8a) illustrates a middle position of the eyebox, FIG. 8b) a high position, and FIG. 8c) a low position. Due to the optical design of head-up displays, the virtual image is only detectable if the viewer's eyes are inside the eyebox. By adjusting the optics of the head-up display, e.g., by adjusting the mirror, this eyebox can be shifted in the vertical alignment thereof. The available adjustment range is indicated by the vertical double arrow and the rectangle shown with dotted lines. Therefore, the vertical position of the field of view 62 is defined via the adjustment in the optics, i.e., the look-down angle (downward viewing angle, i.e., the angle of the viewing axis relative to the road) in relation to the center point of the eyebox. If the eyebox is set too high or too low for the driver, the image of the display is truncated at the upper or lower edge of the field of view 62. When the setting is correct, on the other hand, the driver can see the image fully. In addition, tolerance areas 63 result above and below the field of view 62. If the field of view 62 had a greater vertical extension, the virtual image would also be visible in these areas.

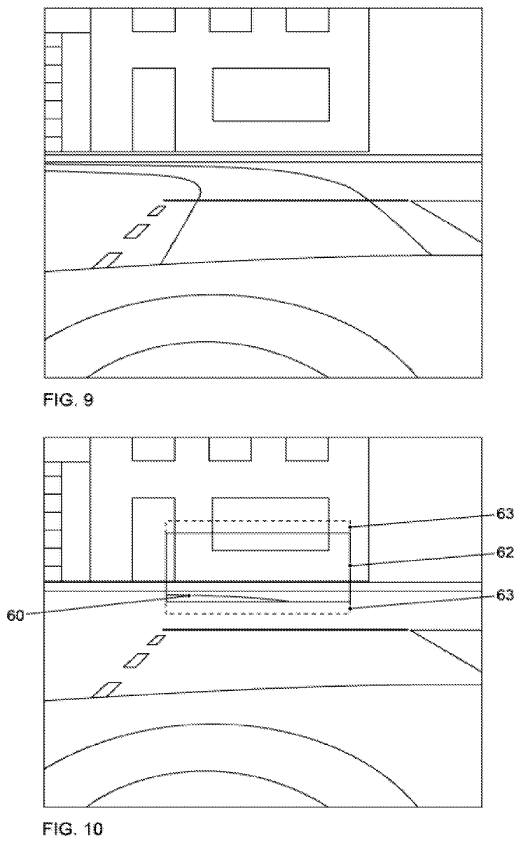

FIG. 9 shows a turning situation that is to be illustrated by means of an augmented reality display. Shown is a visualized trajectory of travel that reflects a course of a turn. This is not an actual augmentation by means of an augmented reality head-up display but merely the visualization of a trajectory of travel that utilizes the driver's field of view completely.

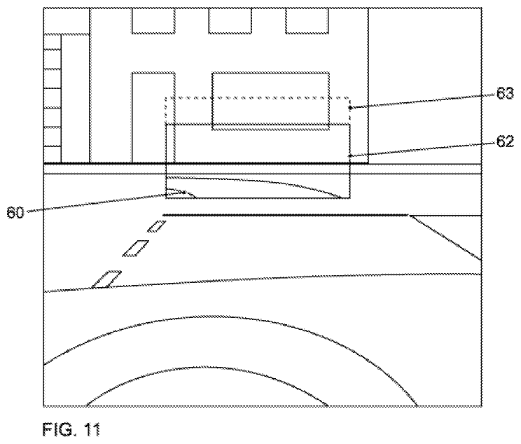

FIG. 10 shows an augmented reality display of a navigation marking 60 without shifting the eyebox. The augmented reality head-up display is used to show an augmentation in the form of a navigation marking 60, which corresponds to the trajectory of travel as shown in FIG. 9. Because of the short distance to the intersection, the display of the contact-analog navigation marking 60 is severely truncated by the field of view 62. The navigation marking 60 is hardly visible as such.

FIG. 11 shows an augmented reality display of the navigation marking 60 with the eyebox shifted consistent with a given situation. In light of the navigation marking 60 that is to be displayed, the eyebox was shifted downward, whereby a significantly larger part of the trajectory of travel becomes visible. Even without a larger vertical extension of the field of view 62, the display of the navigation marking 60 has been improved significantly. By an enlarging the field of view 62, the display can be improved further.

### LIST OF REFERENCE NUMERALS

10 Analyze content to be displayed

11 Prioritize the content to be displayed

12 Adapt a position of an eyebox

20 Apparatus

21 Input

22 Analysis module

23 Control module

24 Control unit

25 Memory

26 Output

27 User interface

30 Apparatus

31 Memory

32 Processor

33 Input

34 Output

40 Motor vehicle

41 Augmented reality head-up display

42 Control device of the augmented reality head-up display

43 Camera

44 Sensor system

45 Navigation system

46 Data transmission unit

47 Assistance system

48 Memory

49 Network

50 Imaging unit

51 Optical module

52 Optical component

53 Projection area

60 Navigation marking

61 Object marking

62, 62′ Field of view

63 Tolerance range

1-11. (canceled)

12. A method for controlling a display of an augmented reality head-up display for a motor vehicle, comprising:
analyzing content that is to be displayed by the augmented reality head-up display; and
adapting a position of an eyebox of the augmented reality head-up display as a function of the content that is to be displayed.

13. The method according to claim 12, wherein a vertical shift of the eyebox of the augmented reality head-up display occurs as a function of the content that is to be displayed.

14. The method according to claim 12, further comprising adapting the position of the eyebox using an adjustment of an optical component of the augmented reality head-up display.

15. The method according to claim 12, further comprising analyzing an image that has been rendered for the display during the analyzing of the content that is to be displayed by the augmented reality head-up display.

16. The method according to claim 15, wherein analyzing the image that has been rendered for the display comprises analyzing color values of the image.

17. The method according to claim 12, further comprising analyzing input data for a rendering of an image for the display, while analyzing the content that is to be displayed by the augmented reality head-up display.

18. The method according to claim 17, further comprising prioritizing the content that is to be displayed.

19. The method according to claim 18, wherein the prioritization comprises a function of a driving situation, or wherein the driving situation can be influenced by a user of the augmented reality head-up display.

20. An apparatus for controlling a display of an augmented reality head-up display for a motor vehicle, comprising:
an analysis module for analyzing content that is to be displayed by the augmented reality head-up display; and
a control module for adapting a position of an eyebox of the augmented reality head-up display as a function of the content that is to be displayed.

21. The apparatus according to claim 20, wherein the analysis module and control module are configured to enable a vertical shift of the eyebox of the augmented reality head-up display as a function of the content that is to be displayed.

22. The apparatus according to claim 20, wherein the analysis module and control module are configured to adapt the position of the eyebox using an adjustment of an optical component of the augmented reality head-up display.

23. The apparatus according to claim 20, wherein the analysis module and control module are configured to analyze an image that has been rendered for the display during the analyzing of the content that is to be displayed by the augmented reality head-up display.

24. The apparatus according to claim 23, wherein the analysis module and control module are configured to analyze the image that has been rendered for the display by analyzing color values of the image.

25. The apparatus according to claim 20, wherein the analysis module and control module are configured to analyze input data for a rendering of an image for the display, while analyzing the content that is to be displayed by the augmented reality head-up display.

26. The apparatus according to claim 25, wherein the analysis module and control module are configured to prioritize the content that is to be displayed.

27. The apparatus according to claim 26, wherein the prioritization comprises a function of a driving situation, or wherein the driving situation can be influenced by a user of the augmented reality head-up display.

28. A computer program with instructions which, upon being executed by a computer, cause the computer to:
analyze content that is to be displayed by the augmented reality head-up display; and
adapt a position of an eyebox of the augmented reality head-up display as a function of the content that is to be displayed.

29. The computer program according to claim 28, wherein a vertical shift of the eyebox of the augmented reality head-up display occurs as a function of the content that is to be displayed.

30. The computer program according to claim 28, further comprising adapt the position of the eyebox using an adjustment of an optical component of the augmented reality head-up display.

31. The computer program according to claim 28, further comprising analyze an image that has been rendered for the display during the analyzing of the content that is to be displayed by the augmented reality head-up display.
